(19) United States
(12) Patent Application Publication
(10) Pub. No.: US 2023/0410214 A1
(43) Pub. Date: Dec. 21, 2023

(54) SYSTEM AND METHOD FOR SUPERVISING EXPENSE OR INCOME

(71) Applicant: Eliahu Kadoori AVIVI, Alfey Menashe (IL)

(72) Inventor: Eliahu Kadoori AVIVI, Alfey Menashe (IL)

(21) Appl. No.: 18/027,631

(22) PCT Filed: Nov. 11, 2021
(86) PCT No.: PCT/IL2021/051348

§ 371 Date: Mar. 22, 2023

Related U.S. Application Data
(60) Provisional application No. 63/113,850, filed on Nov. 14, 2020.

(51) Int. Cl. G06Q 40/12

(52) U.S. Cl. CPC G06Q 40/12

(57) ABSTRACT

A computerized-method for an automatic control of business income and expenses by a uniform-processing of invoices, is provided herein. The computerized-method includes: (i) identifying invoices and related-documents in a received stream of searchable-uniform-format-documents; (ii) sorting the identified invoices and related-documents into a plurality of queues, based on document-type, document-author and document-recipient; (iii) for each invoice or related-documents in each queue, extracting and validating item or service details and converting the validated item or service details into uniform-format-tables to be stored in a data-store; (iv) assigning items or services, to entries in the uniform-tables of supplied and ordered items and services to detect discrepancies, and operating an Artificial-Intelligence (AI) model to learn from previous user-assignments of the items or services; (v) handling the detected discrepancies by the AI-model based on previous user-resolution of such discrepancies; (vi) displaying on a display-unit of a computerized-device one or more unresolved-discrepancies, for a user-remedy thereof.

### TECHNICAL FIELD

The present disclosure relates to the field of data analysis and more specifically to processing a stream of incoming and outgoing invoices and related documents and detecting abnormal expense or income.

### BACKGROUND

Incoming invoices include amounts due to vendors or service providers (hereby named “suppliers”). However, invoices are accepted by regulators as a legal evidence for the relevant expenditure or income, which should be verified to be an authentic document, issued by the relevant vendor or service provider. Document authentication is not fully automated in current technologies and requires human attention to validate it. Furthermore, though an invoice is a legal evidence of a relevant expenditure or income, currently, there is no universal standard for such a document or to its language. Also, there is no obligation to include in it the details of the specific items or services, for which payment is due, and it should be looked for in several attached or referenced documents, such as supplier waybills or reports of invested time and materials.

Therefore, determining for exactly which items or services is the customer required to pay may involve detection of the specific documents which include the relevant data and also accurate extraction of relevant data from each such document. Such activities are not fully automated in current technologies and may involve intensive human resources to detect and verify the relevant data.

Commonly, the items, i.e., goods or services and related amounts in each invoice has to match the amounts of goods or services in corresponding purchase orders and the amounts that have been received. Similarly, outgoing invoices include amounts to be received for goods or services which were provided. The amounts should also add up to a sum that should not exceed a preconfigured budget. A related document to the invoice may be a proforma invoice, which has been issued before the goods and services have been received.

However, the description and catalog numbers used by the supplier to define the supplied items might be different from the description and catalog numbers in the relevant customer purchase orders and in the customer reports of receiving the relevant goods. In such cases automatic matching may fail and user intervention is needed to match those apparently different items or services. One of the popular solutions to the “matching problem” is to force the supplier to specify the proper matching via a relevant portal, otherwise the supplier won't be paid. Yet, such a solution cannot be imposed on every supplier.

Also, due to various reasons there may be different types of discrepancies between the matched items and services, such as the quantity, the unit price and the total price in the invoice vs. the ordered or supplied quantity, or the unit price and total price in the purchase order. Current accounting applications require human intervention to handle such discrepancies.

Accordingly, there is a need for a technical solution for an automatic management and control of business income and expenses by a uniform processing of invoices to detect abnormal expense or income for remedy thereof.

### SUMMARY

There is thus provided, in accordance with some embodiments of the present disclosure, a computerized-method for an automatic control of business income and expenses by a uniform processing of invoices.

Furthermore, in accordance with some embodiments of the present disclosure, the computerized-method may include: (i) receiving a stream of searchable uniform format documents; (ii) identifying invoices and one or more related documents in the received stream of searchable uniform format documents; (iii) sorting the identified invoices and related documents into a plurality of queues, based on document type, document author and document recipient; (iv) for each invoice or one or more related documents in each queue, extracting and validating item or service details and converting the validated item or service details into uniform format tables to be stored in a data store; (v) assigning items or services for which a supplier requires payment, to entries in the uniform tables of supplied and ordered items and services to detect discrepancies, and operating an Artificial Intelligence (AI) model to learn from previous user assignments of the items or services by the user; (vi) handling the detected discrepancies by the AI model based on previous user resolution of such discrepancies; and (vii) displaying on a display unit of a computerized-device one or more unresolved discrepancies, for a user remedy thereof. The detected discrepancies may be selected from at least one of: one or more supply-discrepancies and one or more Purchase Order (PO)-discrepancies.

Furthermore, in accordance with some embodiments of the present disclosure, for each queue in the plurality of queues, the computerized-method may further include checking if an item or service price within the identified invoices exceeds a predetermined budget, which may be defined in the purchase order for the specific item or service or to an items-group to which the item or service relates, and may display on the display unit of the computerized-device a price which exceeds a predetermined budget.

Furthermore, in accordance with some embodiments of the present disclosure, the computerized-method may include identifying the one or more supply-discrepancies and the one or more PO-discrepancies based on an Artificial Intelligence (AI) model, the AI model may learn a tolerance-percentage and identifying when the supply-discrepancies and the PO-discrepancies exceed the tolerance-percentage.

Furthermore, in accordance with some embodiments of the present disclosure, the item or service details and the supplied item or service details may comprise: a quantity, a unit price and a total price.

Furthermore, in accordance with some embodiments of the present disclosure, the AI model may further compare each item or service unit price to item or service unit price during a preconfigured period

Furthermore, in accordance with some embodiments of the present disclosure, the one or more related documents may include ordered and supplied quantities and prices of one or more items or services which are detailed in the identified invoices and one or more related documents.

Furthermore, in accordance with some embodiments of the present disclosure, the computerized-method may further comprise after the sorting, confirming authenticity of each invoice and related document, in the identified invoices and one or more related documents

Furthermore, in accordance with some embodiments of the present disclosure, the authenticity confirmation may include checking a compliance with regulatory demands.

Furthermore, in accordance with some embodiments of the present disclosure, the computerized-method may further comprise assigning supplied items or services to the invoice, searching for an invoice in the uniform format tables which may be stored in the data store and which may be assigned to the supplied items or services to identify a copy of the invoice and to mark the invoice as such.

Furthermore, in accordance with some embodiments of the present disclosure, the data store may include one or more uniform structured tables.

Furthermore, in accordance with some embodiments of the present disclosure, the computerized-method may further comprise inferring a price deviation to each item or service and assigning to an expense category.

Furthermore, in accordance with some embodiments of the present disclosure, the computerized-method may further comprise saving each invoice and related one or more documents and the confirmed assignment of each item or service within it in a data store in a universal format.

Furthermore, in accordance with some embodiments of the present disclosure, the computerized-method may further comprise retrieving each invoice and related one or more documents and the confirmed assignment of each item or service from the data store and may send it to the recipient of an invoice in a uniform format table, along with the invoice itself, to enable automatic processing by the recipient, while each item or service, for which payment is required by the supplier, may be assigned to a confirmed supply and to a corresponding purchase order.

Furthermore, in accordance with some embodiments of the present disclosure, the computerized-method may further comprise operating a categories-AI module to report expenses and income for each learned category.

Furthermore, in accordance with some embodiments of the present disclosure, each learned category may be identified by the categories-AI module based on a ledger, which may include categorization of each income and expense, or based on a predetermined manual categorization for each item or service.

Furthermore, in accordance with some embodiments of the present disclosure, when the details of the items or services, for which a supplier requires payment, do not exist in the invoice but in attached or referenced documents, the computerized-method may further comprise extracting the details of the items or services from those documents and aggregating them into a uniform format table to be stored in the data store.

Furthermore, in accordance with some embodiments of the present disclosure, the computerized-method may further include (i) assigning each item or service to an expenditure category, which is learned from previous user assignment of such an item or service; and (ii) comparing prices and quantities of each item or service to previous prices and quantities, to detect irregular one or more monetary transactions.

Furthermore, in accordance with some embodiments of the present disclosure, the computerized-method may further include verifying an originality and authenticity of each identified invoice and related documents, by confirming the identity of the supplier and the recipient of the document and verifying that the document looks like previous documents of the same type from the same supplier and the same recipient and that the invoice and related documents are digitally signed by the supplier or by a person who scanned the document, and when the invoice and related documents, which should be confirmed for originality and authenticity, according to regulations, are not verified then the computerized-method may further include enabling a user to check the invoice and related documents and confirm its originality and authenticity by digitally signing the document, according to regulations.

Furthermore, each invoice and related document may be checked for compliance with regulatory demands to confirm its authenticity and when a failure to comply with the originality and authenticity verification may be detected, a notification may be sent to a user for intervention.

Thus, there is further provided a computerized-system for an automatic control of business income and expenses by a uniform processing of invoices. The computerized-systems may include: one or more processors, a data store and a memory to store the data store.

Furthermore, in accordance with some embodiments of the present disclosure, the one or more processors may be configured to: (i) receive a stream of searchable uniform format documents; (ii) identify invoices and one or more related documents in the received stream of searchable uniform format documents; (iii) sort the identified invoices and related documents into a plurality of queues, based on document type, document author and document recipient; (iv) for each invoice or one or more related documents in each queue, extract and validate item or service details and convert the validated item or service details into uniform format tables to be stored in the data store; (v) assign items or services for which a supplier requires payment, to entries in the uniform tables of supplied and ordered items and services to detect discrepancies, and operating an Artificial Intelligence (AI) model to learn from previous user assignments of the items or services by the user; (vi) handle the detected discrepancies by the AI model based on previous user resolution of such discrepancies; and (vii) display on a display unit of a computerized-device one or more unresolved discrepancies, for a user remedy thereof.

### BRIEF DESCRIPTION OF THE DRAWINGS

FIG. 1 schematically illustrates a high-level diagram of a computerized-system for an automatic control of business income and expenses by a uniform processing of invoices, in accordance with some embodiments of the present disclosure:

FIGS. 2A-2B are a high-level workflow of a computerized-method for an automatic control of business income and expenses by a uniform processing of invoices, in accordance with some embodiments of the present disclosure:

FIG. 3 is a high-level diagram of extraction and verification of items and services, in accordance with some embodiments of the present disclosure; and

FIG. 4 is an example of a uniform expenditure and income table, in accordance with some embodiments of the present disclosure.

### DETAILED DESCRIPTION

In the following detailed description, numerous specific details are set forth, in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing.” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “uniform processing of invoices” as used herein refers to a process of extracting details of every item or service, for which the supplier requires payment, from an invoice and any related one or more documents, and converting the data into a uniform structured table, which also includes the data about the confirmed supplied quantities of the relevant item or services and the quantities and prices in the matching purchase order. This uniform processing enables a universal method to supervise every expenditure and income.

The terms “document type” and “document category” are interchangeable and refer to the category of a document which is received by a receiver from a transmitter, e.g., author, such as, invoice, vehicle insurance policy, pricelist, lawsuit, insurance policy, purchase order etc.

The term “document”, or “searchable uniform format document”, relates to any non-handwritten electronic document, in a format which preserves the image of each page and relates the corresponding text to the image. For example, searchable Portable Document Format (PDF), which includes a hidden text layer under the displayed image layer.

The term “expenditure category”, “expense category” and “expense class” are interchangeable and as used herein refers to an assignment of the same category of expense to a group of items or services of related nature. For instance, an executive chair and conference table and office desk might be assigned to “office furniture” expenditure category.

The term “items-group” as used herein refers to items or services relating to a common group or family of products or services. For example, the items pen, pencil, ruler, eraser may relate to “stationery” items-group.

Existing accounting solutions do not have the ability to detect discrepancies in item or service details or in the supplied item or service details, such as quantity, unit price and total price, whenever no correlation is detected between items description and catalog numbers in the received invoices and the items description and catalog numbers of the reported received items or in the customer purchase order.

A tremendous amount of human resources may be required for every commercial transaction, for reading each invoice and extracting key data from it, and then to comparing it to the relevant data in related documents, such as waybills, purchase orders, price lists etc.

Accordingly, there is a need for a technical solution that will overcome the lack of correlation between items description in item or service details and in supplied item or service details. The needed technical solution has to enable a digital transformation of every invoice and its related documents with no change to existing software applications.

Moreover, there is a need for a system and method for an automatic control of business income and expenses by a uniform processing of invoices by an Artificial Intelligence (AI) models instead of managing and supervising the income and expenditure in an organization by human resources.

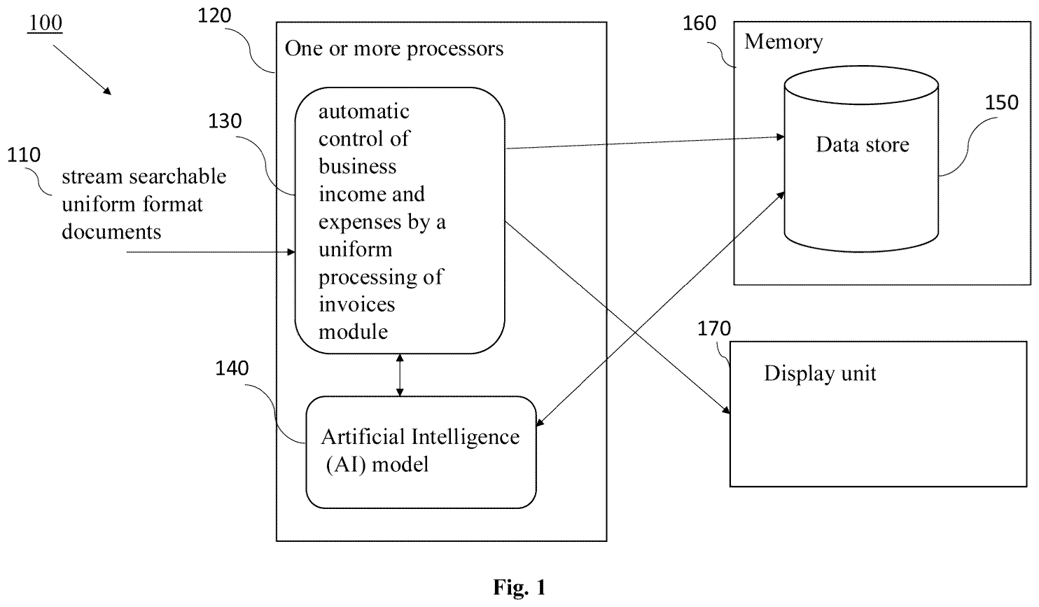

FIG. 1 schematically illustrates a high-level diagram of a computerized-system 100 for an automatic control of business income and expenses by a uniform processing of invoices, in accordance with some embodiments of the present disclosure.

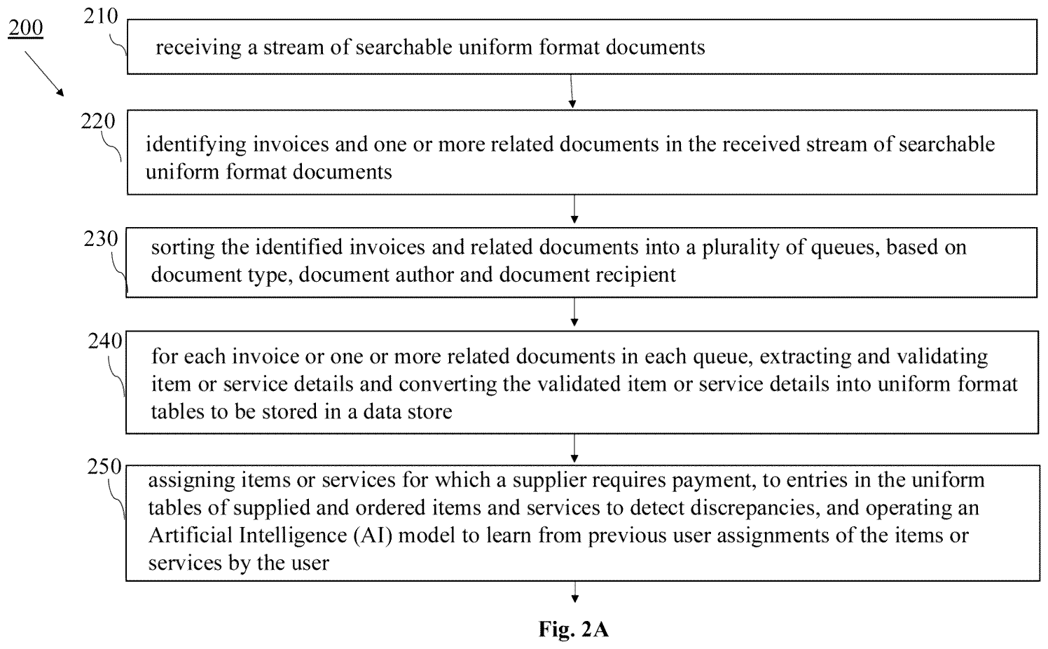

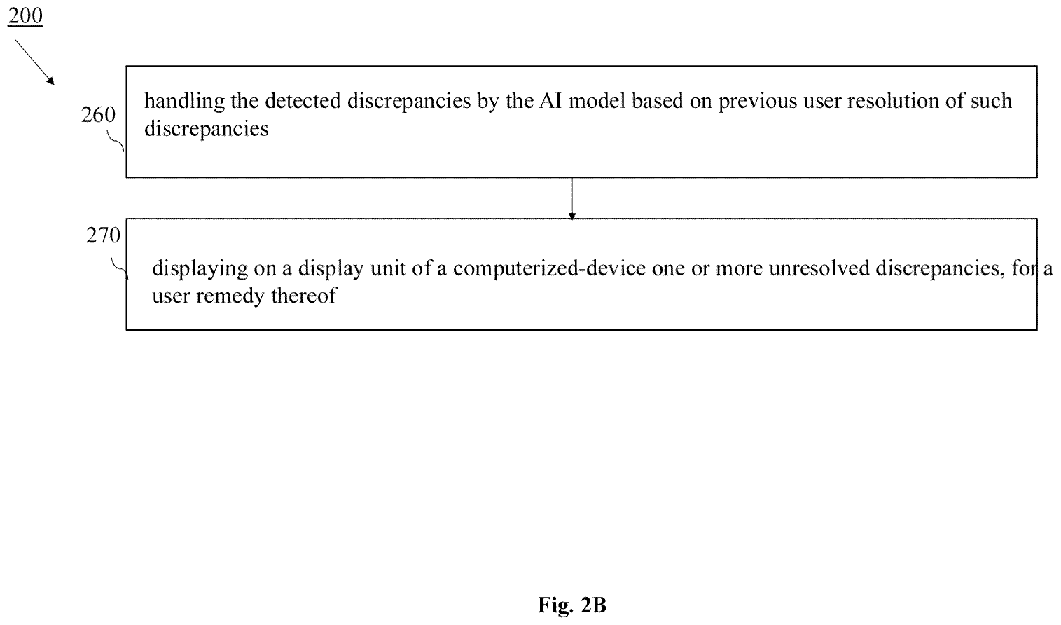

According to some embodiments of the present disclosure, a computerized-system, such as computerized-system 100 may implement by one or more processors 120 a module, such as automatic control of business income and expenses by a uniform processing of invoices module 130, and such as computerized-method 200 in FIGS. 2A-2B for an automatic control of business income and expenses by a uniform processing of invoices.

According to some embodiments of the present disclosure, the computer-system 100 may receive a stream of searchable uniform format documents 110.

According to some embodiments of the present disclosure, the searchable uniform format documents may be every incoming and outgoing invoice, including all related documents, such as customer confirmation of receiving the items and services detailed in the invoice, pricelists, purchase orders, waybills, documents detailing invested time and materials and the like. The stream of searchable uniform format documents 110 may be captured by monitoring every input source, such as email, scanner, folder, website and every output source, such as print queue, outgoing email, thus, replacing human labor to search and fetch all such documents.

According to some embodiments of the present disclosure, the automatic control of business income and expenses by a uniform processing of invoices module 130 may identify invoices and one or more related documents in the received stream of searchable uniform format documents 110 and may sort the identified invoices and the one or more related documents into a plurality of queues, based on document type, document author and document recipient.

According to some embodiments of the present disclosure, the authenticity of each invoice and its compliance with regulatory demands may be automatically verified and confirmed, to ensure that the invoice and related document may be saved as a legal evidence of the relevant expenditure or income.

According to some embodiments of the present disclosure, the authenticity verification and confirmation may include a verification that the vendor and recipient are identified within the invoice and that the invoice is digitally signed by the vendor. Otherwise, if the invoice is a scanned or photographed copy, then the document should include two confirmed digital signatures: (i) by the person who scanned the document and confirmed that it is an authentic copy of the original and (ii) by another person, confirming that the invoice complies with all regulatory demands.

According to some embodiments of the present disclosure, the extraction and validation of all key data from each invoice and from all related one or more documents, including unmanned correction of Optical Character Recognition (OCR) errors in scanned or photographed pages, is disclosed in PCT Application No. PCT/IL2021/050749.

PCT Application No. PCT/IL2021/050749 discloses “textographic learning” algorithms which assume that invoices and related documents, from the same vendor or service provider, i.e., “supplier” and the same recipient, may have similar graphical structure, similar table structure, similar location of key data within the document and similar repetitive patterns. Accordingly, it detects, validates and corrects all key data. Numerical data within the invoice is also checked by, for example, (i) the prices of all items sum up to a grand total detected in the invoice; (ii) the multiplication of a unit price by the quantity equals, after subtracting possible discount, to the total unit price; and (iii) the total price of the invoice plus the Value Added Tax (VAT) sum equals the sum in the invoice.

According to some embodiments of the present disclosure, for each invoice or one or more related documents in each queue, a module, such as automatic control of business income and expenses by a uniform processing of invoices module 130 for automatic control of business income and expenses by a uniform processing of invoices, may extract and validate item or service details and may convert the validated item or service details into uniform format tables to be stored in a data store, such as data store 150 in memory 160. The data store 150 may include one or more uniform structured tables. Each invoice and related one or more documents and the confirmed assignment of each item or service within it in may be saved in the data store in a universal format.

According to some embodiments of the present disclosure, for each queue in the plurality of queues, the module, such as automatic control of business income and expenses by a uniform processing of invoices module 130 may further include checking if an item or a service price within the identified invoices exceeds a predetermined budget. The predetermined budget may be defined in the purchase order for the specific item or service or to an items-group to which the item or service relates.

According to some embodiments of the present disclosure, the module, such as automatic control of business income and expenses by a uniform processing of invoices module 130 may display on the display unit of a computerized-device, one or more unresolved discrepancies, for a user remedy thereof. For example, a price which exceeds a predetermined budget.

According to some embodiments of the present disclosure, the conversion of the extracted data from each invoice and from each document of the related one or more documents into a uniform tabular structure, may enable a universal processing of the relevant information, with no human intervention. Such uniform tabular structure may be implemented for example, via an Excel file, with detailed information about each item or service, e.g.: description, catalog number, unit price, quantity, agreed discount, total price for relevant quantity of the specified item or service and the like.

According to some embodiments of the present disclosure, each such uniformly structured file, which may include all the extracted data from one or more documents, with details of every item or service, along with the original document itself, which may be also automatically digitally signed, to confirm its authenticity, may be saved into two folders, corresponding to the outgoing invoices or incoming invoices. Each folder may include several subfolders with related documents.

For example, as follows:

Outgoing Invoices issued by a user, may include these subfolders:
1) price quotes and pricelists issued by the relevant user.
2) purchase orders issued by any of the user's customers.
3) documents detailing supplied items or services by the user.
4) approval of receipt of items or services by the user's customers.
   Incoming Invoices addressed to a user, may include these subfolders:
1) price quotes and pricelists issued by the relevant user's suppliers.
2) purchase orders issued by the user.
3) documents detailing supplied items or services to the user.
4) approval of receipt of items or services by the user.

According to some embodiments of the present disclosure, missing details, about the items or services for which the recipient of the invoice may be requested to pay, may be completed from the related one or more documents. For example, an invoice may include the following lines:
“Items supplied in waybill 1377592, for a total price of $1,500.
Time and materials detailed in document 35447—$2,757.”
   key data may be extracted from the invoice and related documents, such that details of specific items or services may be fetched from the invoice and related documents and inserted into the uniform tabular structure of the relevant invoice, thus saving tremendous amounts of human labor, which may be required to detect the items or services details for which the recipient of the invoice is requested to pay.

According to some embodiments of the present disclosure, the module, such as automatic control of business income and expenses by a uniform processing of invoices module 130 may assign items or services for which a supplier requires payment, to entries in the uniform structured tables of supplied and ordered items and services to detect discrepancies, and may operate an Artificial Intelligence (AI) model, such as AI model 140, to learn from previous user assignments of the items or services by the user.

According to some embodiments of the present disclosure, the automatic control of business income and expenses by a uniform processing of invoices module 130 may further include identifying one or more supply-discrepancies and one or more Purchase Order (PO)-discrepancies based on an operation of the AI model 140. The AI model 140 may learn a tolerance-percentage based on user confirmations and rejections of discrepancies over time and may identify when the supply-discrepancies and the PO-discrepancies exceed the tolerance-percentage. The item or service details and the supplied item or service details may include a quantity, a unit price and a total price.

According to some embodiments of the present disclosure, the one or more related documents, may include ordered and supplied quantities and prices of one or more items or services which may be detailed in the identified invoices and in the one or more related documents.

According to some embodiments of the present disclosure, after the sorting, confirming authenticity of each invoice and related document, in the identified invoices and one or more related documents. The authenticity confirmation includes checking a compliance with regulatory demands.

According to some embodiments of the present disclosure, the automatic control of business income and expenses by a uniform processing of invoices module 130 may further assign supplied items or services to the invoice, and search for the supplied items or services which are assigned to the invoice in the uniform format tables which may be stored in the data store 150 to identify a copy of the invoice and to mark the invoice as such. Thus, duplicate charges for the same invoice may be prevented.

According to some embodiments of the present disclosure, over time a searchable archive of invoices and related documents may be created and stored in the data store 150. Each processed invoice, and all the relevant related documents to it, and the detailed information about the key data in each document may be saved into a relevant searchable archive.

According to some embodiments of the present disclosure, the data may include, for example:
a. the invoice file, with links to one or more related documents. Each document may be in a searchable Portable Document Format (PDF) format, and digitally signed according to relevant regulations, as an evidence of its authenticity.
b. structure of every page in each document, including column structures.
c. the key data extracted from each document.
d. structure and location of the key data in every document.

According to some embodiments of the present disclosure, this searchable archive, in addition to the learning by the AI model 140 from human verification of the automated process, may provide the raw data, from which a knowledge base may be created, which aids the automatic decisions, as described in detail below.

According to some embodiments of the present disclosure, dual counting of similar income and expenditure may be detected and avoided. Each invoice or income may be recorded only once in the archive. Therefore, before saving any invoice into the archive the following search operations may be taken:
a. an archived invoice with the same total sum and same reference number.
b. an archived proforma invoice, preceding the current invoice, with the same total sum and the same detailed items or services.
c. any suspicion of a dual recording of the same expenditure or income may be properly marked and forwarded for a user decision.

According to some embodiments of the present disclosure, a knowledgebase may be created for key data confirmation and for supervising the validity of every detail in the analyzed documents. The knowledge base may include detailed information and statistical data about each item or service from each supplier or service provider, that is initially learned from historic records in the relevant user Enterprise Resource Planning (ERP) system, including purchased items and services in historic invoices and the matched items and services and items-group in the corresponding purchase orders and waybills, and from historic bookkeeping income and expenditure journal.

According to some embodiments of the present disclosure, the initial information in the knowledge base may be automatically updated, by learning from every user intervention to handle any new exception or resolve any irregularity or discrepancy. The information in the knowledge base may include for example:
a. structure of every relevant document type from each supplier, typical headers and footers in each page, document numbering pattern, line lengths and line spacing, vocabulary and typical phrases, repetitive patterns, typical font types, typical column structure and column-headers, etc.
b. structure and location of key data within the document, font type and font size of each key data and its location within the document or within a relevant column-structure, typical characteristics of each key-data structure, e.g., a number with exactly two digits right to the decimal point, or a digital counter preceded by the letters ABC, etc.
c. details of every ordered or supplied item or service, including pricing, assignment into a relevant expenditure category in bookkeeping journal, alternate descriptions or catalog numbers of each item or service, its relation to a relevant items-group, etc.
d. statistical data about every supplied or ordered item and service, including averages and standard deviation about annual/seasonal/monthly supplied or ordered quantities and past prices, already approved by the user, frequency of issuing invoices, typical sum of each invoice etc.
e. acceptable deviation from former prices of each item or service, based on calculated maximal deviation percentage from former average annual/seasonal/monthly prices, which has been approved by the user in former invoices from the same supplier.
f. acceptable deviation from relevant currency conversion ratio, based on calculated maximal deviation percentage from relevant currency conversion ratio which was approved by the user in former invoices from the same supplier.

According to some embodiments of the present disclosure, detected discrepancies by the AI model 140 may be handled based on previous user resolution of such discrepancies. The detected discrepancies may be one or more supply-discrepancies and one or more PO-discrepancies.

According to some embodiments of the present disclosure, a price deviation assigned to an item or service expresses the expected price fluctuations of the item or service from the average price within a predefined period. For example, if an item was sold over the last 3 months for an average price of 100$, and the actual prices were: 98$, 97$, 102$, 104$, 99$—the maximal price deviation from the average of 100$ is up to 4%.

According to some embodiments of the present disclosure, the automatic control of business income and expenses by a uniform processing of invoices module 130 may further include retrieving each invoice and related one or more documents and the confirmed assignment of each item or service from the data store 150 and send it to the recipient of an invoice in a uniform format table, along with the invoice itself, to enable automatic processing by the recipient, while each item or service, for which payment is required by the supplier is assigned to a confirmed supply and to a corresponding purchase order.

According to some embodiments of the present disclosure, a uniform structured data may be forwarded to one or more customers. Every outgoing invoice and related documents preceding it, may be forwarded to the relevant customer, as a uniform structured file, along with the original relevant file, optionally digitally signed. This option may enable easy processing of the document by the customer, avoiding any investments in the extraction of the key data from the document.

According to some embodiments of the present disclosure, items or services in the invoice may be confirmed for essentially being ordered by the recipient of the invoice, also when the description or catalog number of the items or services is different than the items or services details in the invoice. A matching may be operated in such cases, by learning from former matchings of such apparently different items or services and saved in the knowledge base in the data store 150, as related to the same item or service. For example, the list of ordered goods may include “catalog number SM311000—skim milk”, while the matching item in the invoice might be “11 milk 1% CATNO. 179446091”.

According to some embodiments of the present disclosure, items or services in the invoice may be confirmed for essentially being supplied in the referenced quantity, also when the description or catalog number of the items or services is different than the items or services details in the invoice. For example, the list of supplied goods, may include “fruits” in a quantity of 10 kg., while the matching items in the invoice may be: prunes—2 kg., grapes—5 kg., apples—3 kg. A matching may be operated, in such cases, by learning from former matchings of such different items or services, by saving it in a knowledge base in the data store 150 and the details of which are described, as identical or related to the same items-group.

According to some embodiments of the present disclosure, the prices of the items and services, which may be detailed in the invoice, may be confirmed as acceptable. In cases when there is no purchase order or the prices in the purchase order are not identical to the prices in the invoice it may be analyzed and a suggestion whether payment should be made may be provided, or a suggestion that the invoice should be rejected may be provided. The suggestion may be displayed on a display unit, such as display unit 170.

According to some embodiments of the present disclosure, the analysis which may have yielded the suggestion may be operated by the AI model 140 and may be based on the knowledge base in the data store 150. The AI model 140 may learn from human decision in similar cases in the past. For example, if a price deviation of up to 5% from the current price of the item or service was consistently acceptable in former invoices then the AI model 140 may learn that it may approve the payment, or otherwise reject it and may present the suggestion on the display unit 170.

According to some embodiments of the present disclosure, the automatic control of business income and expenses by a uniform processing of invoices module 130 may further include operating a categories-AI module (not shown) to report expenses and income for each learned category. Each learned category may be identified by the categories-AI module based on a ledger, which includes categorization of each income and expense, or based on a predetermined manual categorization for each item or service.

According to some embodiments of the present disclosure, when the details of the items or services, for which a supplier requires payment, do not exist in the invoice but in attached or related documents, the automatic control of business income and expenses by a uniform processing of invoices module 130 may further include extracting the details of the items or services from those documents and aggregating them into a uniform format table to be stored in the data store 150.

According to some embodiments of the present disclosure, the automatic control of business income and expenses by a uniform processing of invoices module 130 may further include: (i) assigning each item or service to an expenditure category, which is learned from previous user assignment of such an item or service; and (ii) comparing prices and quantities of each item or service to previous prices and quantities, to detect irregular one or more monetary transactions.

According to some embodiments of the present disclosure, expenditures or income from the invoice may be classified into categories and may be reported in the relevant bookkeeping journal. The classification may be learned from former classifications of the items and services from the relevant supplier, that are saved in the knowledge base in the data store 150. For example, if all former items from the specific supplier were consistently classified as “furniture” then, the expenditure category for the item may be also expected to be “furniture”.

According to some embodiments of the present disclosure, former human decisions may be learned and then used by the AI model 140 to operate an initial analysis of the historic bookkeeping income and expenditure journal, from which the typical expenditure categories from each supplier may be learned and saved into the knowledge base, as well as statistics about frequency of issuing invoices, average and standard deviations of expenditures from each supplier, etc. Moreover, former human decisions may be used by the AI model 140 to analyze historical information, if exists in the relevant customer Enterprise Resource Planning (ERP), about items or services which have been purchased in former invoices, price deviations in the different invoices, supplied quantities, linkage to relevant purchase orders and waybills, from which the alternate description of each item or service may be learned and the assignment to a common items-group, etc.

According to some embodiments of the present disclosure, the AI model 140 may learn from each and every new user intervention. For example, when a user consistently approves an item price, even if it is higher by 10% from the item list price or its price in the purchase order, then the AI model 140 may learn that a 10% deviation from the specific list price may be automatically approved also in future invoices and the automatic control of business income and expenses by a uniform processing of invoices module 130 may not detect it as a discrepancy to be displayed to the user.

Thus, by the implementation of a module, such as automatic control of business income and expenses by a uniform processing of invoices automatic control of business income and expenses by a uniform processing of invoices module 130, a human intervention as to discrepancies may be required only to resolve incompliance in any of the relevant data fields and whenever significant deviations from former supply patterns or former pricing may be detected.

According to some embodiments of the present disclosure, an automatic control of every income and expenditure may be provided. It may be assumed that signed invoices and the one or more related documents preceding it may be considered as an evidence for every income and expenditure in any business or organization. Therefore, by validating the information in every invoice vs. the ordered and supplied items or services, achieving an automatic supervision of every income and expenditure, which is acceptable by the regulator.

According to some embodiments of the present disclosure, an accurate detection of every detail in an invoice, in any computer system, may be operated but also validates the price and quantity of every item or service vs. all documents related to it, regardless of their language or specific structure.

According to some embodiments of the present disclosure, the implementation of a module, such as automatic control of business income and expenses by a uniform processing of invoices module 130 does not require a change in an existing Enterprise Resource Planning (ERP) system and it may be implemented on each document “as is”, having no additional efforts or investments by the users to change the existing ERP or other existing software.

FIGS. 2A-2B are a high-level workflow of a computerized-method 200 for an automatic control of business income and expenses by a uniform processing of invoices, in accordance with some embodiments of the present disclosure;

According to some embodiments of the present disclosure, operation 210 may comprise receiving a stream of searchable uniform format documents.

According to some embodiments of the present disclosure, the received stream of searchable uniform format documents may be captured incoming or outgoing documents. It may be assumed that every invoice and one or more related documents may be found among all the incoming and outgoing documents of a business or a company.

According to some embodiments of the present disclosure, the captured incoming or outgoing documents may be analyzed, and the following documents types may be selected: invoices, price quotes or pricelists, purchase orders, supplier report about invested time and materials, supply reports and user confirmation for each supply, i.e., related one or more documents. The related one or more documents may also include documents which may be an evidence of an actual payment for the invoices, e.g., receipts, bank account reports etc.

According to some embodiments of the present disclosure, the identified invoices and the related documents may be sorted into a plurality of queues, based on document type, document author and document recipient

According to some embodiments of the present disclosure, the captured documents may include output documents which have been sent to be printed by any computer application.

Accordingly, the captured documents may be taken from the documents spooled in a queue of documents, awaiting the availability of the relevant printer. Every document in this spool may be captured and redirected into e.g., a “virtual PDF printer”, which is a relevant driver converting a spooled document into a Portable Document Format (PDF) file and saves it into a relevant pre-defined folder for output documents.

According to some embodiments of the present disclosure, to enable a selection of specific captured documents, according to a specific user or a computer or an application that issued the relevant print command, each redirected PDF file may be given a unique name, for example the following fields, which may be extracted from the relevant print job details:
1) the unique name of the specific print job, within the print queue.
2) the username, by whom the print job was issued.
3) the name of the application, which created the relevant print job.
4) the specific computer, from which the print job was issued.
5) the exact date and time, in which the print job was issued.
6) total number of pages in the relevant document.

According to some embodiments of the present disclosure, as there may be related documents that may be received as paper-documents and then scanned and saved as image files in folders, the captured documents may be from the scanner output which may be monitored.

According to some embodiments of the present disclosure, email addresses may be monitored to capture invoices and related one or more documents. Every email address which may include invoices and other related documents may be monitored. The attachments to emails in the email address may be converted to PDF format, e.g., via a “virtual PDF printer”. Each such PDF file may be given a unique name, combined of several fields, which may indicate to which specific email the relevant file was attached. For example, as follows:
1) The original name of the file, which was attached to the relevant email.
2) The exact date and time, in which the original file was created.
3) The exact date and time, in which the relevant email was received.
4) The email address of the mail sender.
5) The email address of the mail addressee.
6) The subject of the relevant email, to which the file was attached.

According to some embodiments of the present disclosure, predefined web addresses may be monitored to capture invoices and related documents.

According to some embodiments of the present disclosure, when a user has already saved part of the invoices or related documents into specific folders, then the specific folders may be configured to be monitored for the invoices or related documents.

According to some embodiments of the present disclosure, operation 220 may comprise identifying invoices and one or more related documents in the received stream of searchable uniform format documents.

According to some embodiments of the present disclosure, specific document types may be selected, from all input and output documents, by detecting the type of each document and selecting only invoices and related documents. The detection of the document type may be operated as disclosed in PCT Application No. PCT/IL2021/050749.

PCT Application No. PCT/IL2021/050749, discloses a system and a method to determine a type of a document, and to detect all key data in the document as well as correcting OCR-errors, which may occur while recognizing text in a scanned or photographed paper-document by a relevant OCR process. The extraction of key data disclosed in PCT Application No. PCT/IL2021/050749 may be based on automatic learning of the context and typical patterns, as well as the visual structure, e.g., typical headers and footers in each page, document numbering pattern, line lengths and line spacing, vertical and horizontal lines, typical vocabulary and phrases, repetitive patterns, typical font types, typical column structure and column-headers, etc., of former documents of the same type and from the same author, e.g., “Textographic Learning”.

The “Textographic Learning” assumes that the same type of documents from the same supplier may have similar structure and the key data may appear in similar locations, commonly, at the same horizontal coordinates, with the same font and the same pattern. For example, a numeric counter, a numeric field with exactly 2 digits right to the decimal point, etc.

According to some embodiments of the present disclosure, the printed area in each page may be primarily rescaled to the same size, e.g.: A4 size, with the same margins, to compare data locations in different documents. The physical structure of each page in every analyzed document, and the location, e.g., line number and the coordinates, of every data element, and its font and typical pattern may be saved in an archive that is described in detail below. Automatic control of business income and expenses by a uniform processing of invoices module 130 may use the information in this archive, while building the knowledge base describing the expected structure of each document type and the expected structure and contents of the key data within it.

According to some embodiments of the present disclosure, operation 230 may comprise sorting the identified invoices and related documents into a plurality of queues, based on document type, document author and document recipient.

According to some embodiments of the present disclosure, while detecting the document types and analyzing their structure and contents, each document originality may be verified and its compliance with regulatory demands, including the existence of a digital signature by an authorized officer of the supplier or by a person who scanned the original paper document, to confirm its authenticity. If any incompliance with regulatory demands is detected, or if the structure of the document significantly differs from the structure of previous documents of the same type and the same author, though they are expected to look alike, as disclosed in PCT Application No. PCT/IL2021/050749, or any mandatory detail is missing or uncertainly validated by the unmanned process, a user intervention may be required to resolve the specific problem. In such cases an automatic learning from the relevant user actions may be applied, so that future similar cases may be resolved without human intervention.

According to some embodiments of the present disclosure, the identified invoices and related documents may be sorted into groups, e.g., a plurality of queues. Extracted key data from each incoming or outgoing invoice, may include the related documents to each invoice and it may be automatically converted into a “universal” standard tabular structure, e.g., uniform tabular structure. All the uniformly structured files, including all the extracted data from each relevant document, along with the original document itself, may be saved into one of two folders, corresponding to the outgoing invoices or incoming invoices. Each folder may include several subfolders with documents relating to it, for example as follows:

Outgoing Invoices issued by a user, may include these subfolders:
1) price quotes and pricelists issued by the relevant user.
2) purchase orders issued by any of the user's customers.
3) documents detailing supplied items or services by the user.
4) approval of receipt of items or services by the user's customers.
   Incoming Invoices addressed to a user, may include these subfolders:
1) price quotes and pricelists issued by the relevant user's suppliers.
2) purchase orders issued by the user.
3) documents detailing supplied items or services to the user.
4) approval of receipt of items or services by the user.

According to some embodiments of the present disclosure, operation 240 may comprise for each invoice or one or more related documents in each queue, extracting and validating item or service details and converting the validated item or service details into uniform format tables to be stored in a data store.

According to some embodiments of the present disclosure, the validated item or service details may be converted into uniform format tables to be stored in a data store, such as data store 150 in FIG. 1.

According to some embodiments of the present disclosure, key data may be extracted from each incoming or outgoing invoice and from related documents into a universal standard tabular structure. Each extracted key data may be validated and checked for compliance with the expected location and structure of the relevant key data field, as disclosed in Application No. PCT/IL2021/050749. Furthermore, numerical data may be also verified, as disclosed in PCT Application No. PCT/IL2021/050749, e.g., all item prices should sum up to a grand total, or the multiplication of the unit price by the quantity minus a specified discount should equal the total item price.

According to some embodiments of the present disclosure, when items or services are not detailed in the invoice itself it may be searched in an attached document to the invoice itself. e.g., a document detailing invested time and the price per hour of a relevant service, in which the total price equals the relevant price within the invoice. When the items or services are not detailed in the invoice itself and not detected in an attached document it may be searched in documents which may be referenced by the invoice, e.g., in waybill number 125794, referenced by the invoice or in all documents which detail supplied items or services, for which no corresponding invoice was yet detected. It is expected that the total price of the items and services detailed in those documents will be equal to the corresponding sum within the invoice.

According to some embodiments of the present disclosure, any missing information, which should appear in the uniform structured tables may be expected to be filled by a user and then auto-learned to be automatically filled in the future similar cases by an AI model, such as AI model 140 in FIG. 1. When key data in any of the analyzed invoices or related documents has been already previously extracted and validated, e.g., the key data from purchase orders or waybills already exists in the user's data store, or the supplier sent the relevant data along with the waybill itself then the relevant information may be received and converted into the uniform tabular standard, for example, as follows:
a. Conversion of each invoice details into a uniform table:
   General Information about the invoice
   1) Supplier ID.
   2) Invoice number.
   3) Invoice date.
   4) Total items and services price, excluding VAT, before any discount.
   5) Global discount, excluding VAT, if granted.
   6) Shipment or delivery fees.
   7) Total Invoice sum, excluding VAT.
   8) Total-VAT sum.
   9) Total Invoice sum, including VAT.
   Detailed information about each item or service within the invoice
   10) Sequential number of the item or service within the invoice.
   11) Customer catalog number of the relevant item or service.
   12) Supplier catalog number of the relevant item or service.
   13) Manufacturer model number or barcode of the item or service.
   14) Description of the item or service within the invoice.
   15) Total quantity of the relevant item or service.
   16) Measurement unit of the relevant quantity.
   17) Unit price, excluding VAT, before special discounts.
   18) Discount from unit price, if specified in the invoice.
   19) Currency of the above unit price.
   20) VAT due per relevant quantity of item or service.
   Links to matched documents, including ordered and supplied details
   21) Customer Purchase-Order number, if specified.
   22) Sequential number of the item or service within the Purchase-Order.
   23) Supplier waybill number or another relevant document, detailing the supplied item or service (E.g.: invested time and materials table, import-list, bill of lading preceding the formal tax invoice, etc.).
   24) Date of the waybill or an alternate document detailing the supply.
   25) Sequential number of the item or service within the supply document. 26) Customer Supply-Confirmation number (notice, that if the total supplied quantity of the item is negative—the customer supply-confirmation number might be the former invoice number in which the total supplied quantity of the item was a positive number).
b. Conversion of each confirmed supply into a uniform table:
   General Information about the relevant waybill and the user confirmation:
   1) Supplier ID.
   2) Supplier waybill number.
   3) Waybill date.
   Detailed information about each item or service within the waybill:
   4) Sequential number of the item or service within the waybill.
   5) Customer catalog number of the relevant item or service.
   6) Supplier catalog number of the relevant item or service.
   7) Manufacturer model number or barcode of the item or service.
   8) Description of the item or service within the waybill.
   9) Unique ID of the specific supplied item or the specific person supplying the service.
   10) Number of supplied packages.
   11) Number of units in each package.
   12) Total supplied quantity by the supplier, of the relevant item or service.
   13) Measurement unit of the supplied quantity.
   14) Total confirmed quantity by the user, of the relevant item or service.
   15) Measurement unit of the confirmed quantity.
   16) Unit price, excluding VAT, if specified in the waybill.
   17) Discount from unit price, if specified in the waybill.
   18) Currency of the above unit price.
   19) ID of the officer who confirmed the actual supply.
   20) Email address of the officer who confirmed the actual supply.
   21) Customer confirmation-number of the relevant supply (notice, that if the total supplied quantity of the item is negative—the customer confirmation-number might relate to a former waybill number, in which the supplier specified the alleged supplied quantity).
   22) Customer confirmation date of the relevant supply.
   23) Purchase-Order number, for the relevant item or service.
   24) Sequential number of the item or service within the Purchase-Order.
   25) Project Number, to which the relevant Purchase-Order (P.O.) relates.
   26) Project Name or description, to which the relevant P.O. relates.
c. Converting imported items list into a uniform table:
   General Information about the relevant Import-List
   1) Supplier ID in customer's data base.
   2) Invoice Number, issued by the supplier to the relevant customer.
   3) Invoice Date.
   4) Import-List number.
   5) Import-List date.
   6) Total import fees paid for all the items detailed in the Import-List.
   7) Customs-Broker-ID within the customer's data base.
   8) File number of the relevant import, given by the customs broker.
   9) Invoice number issued by the customs broker, for his services.
   10) Import File number, within the customer's data base.
   Detailed information about each item or service within the Import-List:
   11) Sequential number of the relevant item within the Import-List.
   12) Catalog number of the item within the Import-List.
   13) Description of the item within the Import-List.
   14) Reported quantity of the item, within the Import-List.
   15) Measurement unit of the reported quantity.
   16) Reported unit price of the item, in the Import-List.
   17) Currency of the reported unit price.
   18) VAT due for the relevant item, detailed in the Import-List.
d. Conversion of each P.O. details into a uniform table:
   General Information about the Purchase-Order:
   1) Supplier ID.
   2) Purchase-Order number.
   3) Purchase-Order date.
   4) Project Number, to which the Purchase-Order relates.
   5) Project Name or description, to which the Purchase-Order relates.
   6) ID of the department or branch, which submitted the Purchase-Order.
   7) Email address of the person who submitted the Purchase-Order.
   8) Total budget for the relevant Purchase-Order, excluding VAT.
   9) Total VAT due for the relevant Purchase-Order.
   10) Currency of the budget for the relevant Purchase-Order.
   11) Budget number, for the relevant Purchase-Order, if specified.
   Detailed information about each item or service within the Purchase-Order:
   12) Sequential number of the item or service within the Purchase-Order.
   13) Customer catalog number of the relevant item or service.
   14) Supplier catalog number of relevant item or service.
   15) Manufacturer model number or barcode of the item or service.
   16) Description of the specific item or service in supplier's records.
   17) Description of the specific item or service in customer's data base.
   18) Expenditure-Category of the relevant item or service.
   19) Expenditure-Category-Code of the relevant item or service.
   20) Total ordered quantity of the specific item or service.
   21) Measurement unit of the ordered quantity.
   22) Unit price, excluding VAT, of the ordered item or service.
   23) Agreed discount from the above unit price.
   24) VAT percent due, on the specific item or service.
   25) Currency of the ordered item or service.
   26) Email address of the officer who should confirm the actual supply.

According to some embodiments of the present disclosure, operation 250 may comprise assigning items or services for which a supplier requires payment, to entries in the uniform tables of supplied and ordered items and services to detect discrepancies, and operating an Artificial Intelligence (AI) model to learn from previous user assignments of the items or services by the user.

According to some embodiments of the present disclosure, the price and quantity of each item or service may be validated. The details of each item or service e.g., description, price, quantity etc., in any analyzed invoice may be verified vs. the data extracted from the relevant purchase orders and supply documents, e.g., import-list, waybill, user confirmation for receiving the items or service, etc., as well as vs. the information in the relevant knowledge base or vs. information from the user's ERP about ordered or supplied items or services. Assignment of an item or service to an expenditure category might be also confirmed vs. similar assignments of a similar item or service in former invoices or in former purchase-orders from the same supplier into a similar expenditure category.

According to some embodiments of the present disclosure, every item or service detailed in the invoice may be further verified by matching it with similar items or services detailed in preceding purchase-orders and relevant confirmed-supply documents. To determine the specific supplied or ordered items which match a specific item or service within an invoice uniform tables corresponding to the specific purchase orders and waybills from the relevant supplier, referred to in the invoice may be searched. If no such reference has been found within the invoice, then all the uniform structured tables corresponding to the purchase orders, in which the relevant ordered items or services from the specific supplier were not fully supplied yet may be searched, and all the confirmed-supply records, from the specific supplier, of items or services for which no matching invoice was found yet.

According to some embodiments of the present disclosure, a match between an item or service, detailed in an invoice, and the ordered or supplied items or services may occur when:
a. they have the same catalog number, or, else, if the matching algorithms already learned, from previous human matching, as hereby detailed, that there are several equivalent catalog numbers to the same item or service—one of them should match. When they have the same description, or, else, if the AI model has learned, from previous user matching, that there are several alternate descriptions to the same item or service then one of them should match. When they relate to the same items-group, automatically learned from previous human matching of such items, e.g., pens, pencils, marker pens etc., detailed as separate items in an invoice or in a supply document, may be related to the same items-group, named “stationery” within the customer purchase order.
b. they have the same unit price, or when the AI model has learned, from previous user matching, what is an acceptable price deviation, when the unit price difference is less than the acceptable price deviation. If the price of a supplied item or service is not explicitly mentioned in the relevant supply document it may be taken from the relevant purchase order, or, if exists, or else from a relevant supplier pricelist or price quote or from previous invoices including the same item or service.
c. the total number of units of the relevant item or service in the invoice do not exceed the ordered number of units and the summation of all the supplied quantities of the matching items or services. Or, the total price of the specific item or service within the invoice equals, within the acceptable price deviation, the summation of the prices of all the matching supplied items or services.

According to some embodiments of the present disclosure, when there is no match or when there is an uncertain match or if the quantity of the item in the invoice exceeds the quantity in the relevant purchase-order or waybill then a user intervention may be needed to resolve the specific problem, and from the user intervention. E.g., matching of items or services, differing in description or catalog number, the AI model may learn to relate them to the same items-group and what might be the acceptable price deviation for matching such items or services.

According to some embodiments of the present disclosure, the expenses or income detailed in an invoice may be categorized. According to bookkeeping practice, each item or service, detailed in an invoice, should be assigned to a predefined expenditure category, e.g., Furnitures. Labor, Food etc. To be able to apply unmanned assignment of each item or service to the proper expenditure category, the AI model may learn from previous user assignments of each item or service into a specific expenditure category. When a specific item or service was not assigned yet to any expenditure category, but all the formerly supplied items or services from the specific supplier, within a predefined period, were assigned to the same expenditure category, it may be assumed that the current item or service should be also assigned to that expenditure category.

According to some embodiments of the present disclosure, operation 260 may comprise handling the detected discrepancies by the AI model based on previous user resolution of such discrepancies.

According to some embodiments of the present disclosure, the detected discrepancies may be selected from at least one of: one or more supply-discrepancies and one or more PO-discrepancies.

According to some embodiments of the present disclosure, the computerized-method 200 may further operate the AI model, such as AI model 140 in FIG. 1, to learn from users' interventions to resolve any ambiguity or incompliance in any of the relevant data fields.

For example,
a. when the user corrects the identity of the invoice supplier the AI model, such as AI model 140, may learn that future invoices with the same visual structure e.g., same headers or footers in each page, similar document numbering pattern, similar line lengths and line spacing, similar column-structure with similar fonts, etc. may be probably from the same supplier.
b. when an item is related to a purchase-order despite different descriptions or catalog numbers the AI model, such as AI model 140 in FIG. 1, may learn that those apparently different item descriptions are practically equivalent or belong to the same items-group.
c. when the user consistently approves a unit price of an item or service despite difference from its list price or its price in the purchase order or in former invoices, the AI model, such as AI model 140 in FIG. 1, may learn, after several predefined number of such approvals, that a similar price deviation might be acceptable while automatically validating future invoices.
d. when the user approves a currency conversion ratio which is higher than the currency ratio on the invoice date by x %, the AI model, such as AI model 140 in FIG. 1, may learn, after several predefined number of such approvals, that a deviation of x % from the expected currency conversion ratio might be still acceptable while automatically validating future invoices.
e. when the user consistently approves the total price of the invoice, though it significantly exceeds the average total price of former invoices, by more than two times the computed standard deviation of the total prices of invoices from similar seasons in former years or from total prices in former months, the AI model, such as AI model 140 in FIG. 1, may learn, after several predefined number of such approvals, that such a high price deviation e.g., of a monthly electricity bill, is still reasonable, and might be approved in future invoices, without alerting a human for a very high price deviation.

According to some embodiments of the present disclosure, operation 270 may comprise displaying on a display unit of a computerized-device one or more unresolved discrepancies, for a user remedy thereof.

According to some embodiments of the present disclosure, each expenditure or income may be supervised, by comparing the details of each item or service to statistical data about previous prices and supply frequency and quantity, to detect irregularities.

According to some embodiments of the present disclosure, the automatic assignment of the items or services within an invoice into a relevant expenditure category may be subject to final user supervision, as well as any other automated output.

According to some embodiments of the present disclosure, an output of the analysis such as one or more unresolved discrepancies, may be displayed on a display unit for a user remedy thereof. The analyzed document, e.g., the invoice and related documents may be also displayed for user supervision. In the display, any problem or uncertain value may be highlighted, to be verified or corrected by the human supervisor.

According to some embodiments of the present disclosure, optionally, before verifying the automatically detected data a user confirmation may be required to confirm the authenticity of the analyzed document and its compliance with regulatory demands, to be acceptable as a legal evidence of the income or expenditure. Such a user confirmation might be required by the relevant regulator whenever the automatic system cannot confirm the document authenticity. For example, whenever the invoice is not digitally signed by the invoice supplier.

According to some embodiments of the present disclosure, the AI model, such as AI model 140 in FIG. 1, may learn from every user confirmation or correction, so that future similar cases will be resolved without further human intervention.

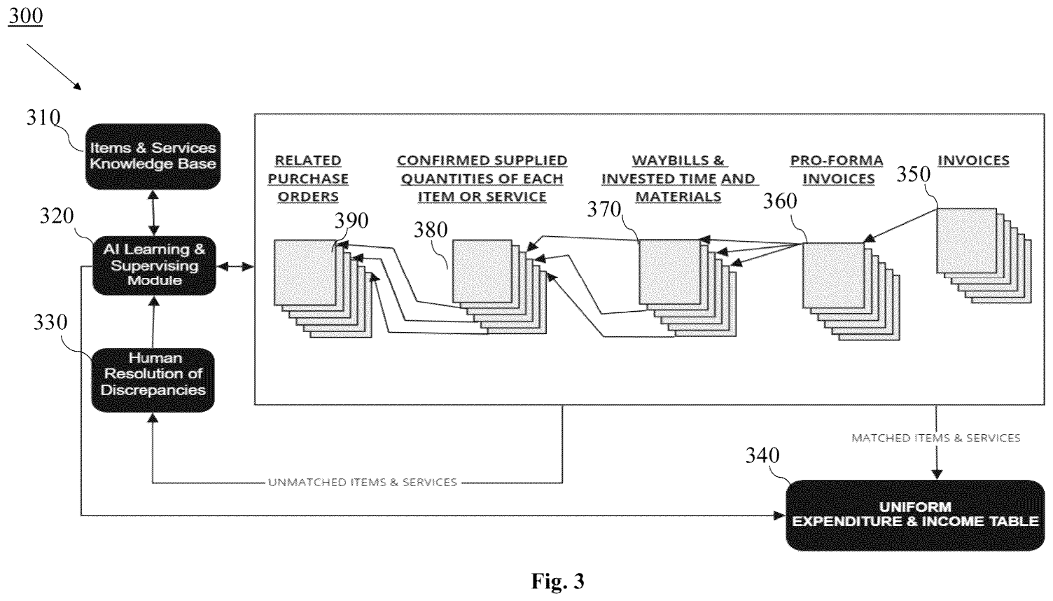

FIG. 3 is a high-level diagram 300 of extraction and verification of items and services, in accordance with some embodiments of the present disclosure.

According to some embodiments of the present disclosure, an extraction and verification of items and services for which supplier requires payment may be operated to be matched with supplied items and services and purchase orders.

According to some embodiments of the present disclosure, identified invoices and related documents 350 may be sorted into a plurality of queues, based on document type, document author and document recipient. The related documents may be an archived invoice with the same total sum and same reference number or proforma invoices 360, preceding the invoice, with the same total sum and the same detailed items or services.

According to some embodiments of the present disclosure, other documents may be waybills and invested time and materials 370, confirmed supplied quantities of each item or service-related purchase order 380 and related purchase order 390.

According to some embodiments of the present disclosure, a knowledgebase, such as items and services knowledge base 310 may receive key data from an AI model, such as AI learning and supervising module 320 for supervising the validity of the analyzed documents, e.g., invoices 350, proforma invoices 360, waybills and invested time and materials 370, confirmed supplied quantities of each item or service 380 and related purchase order 390.

According to some embodiments of the present disclosure, the knowledge base, such as items and services knowledge base 310, may include detailed information and statistical data about each item or service from each supplier or service provider, that is initially learned from historic records in a related user Enterprise resource planning (ERP) system.

According to some embodiments of the present disclosure, the initial information in the knowledge base may be automatically updated by the AI model, such as AI learning and supervising module 320, which may be learning from human resolution of discrepancies, e.g., every user intervention that is handling new exception or resolve any irregularity or discrepancy of unmatched items and services.

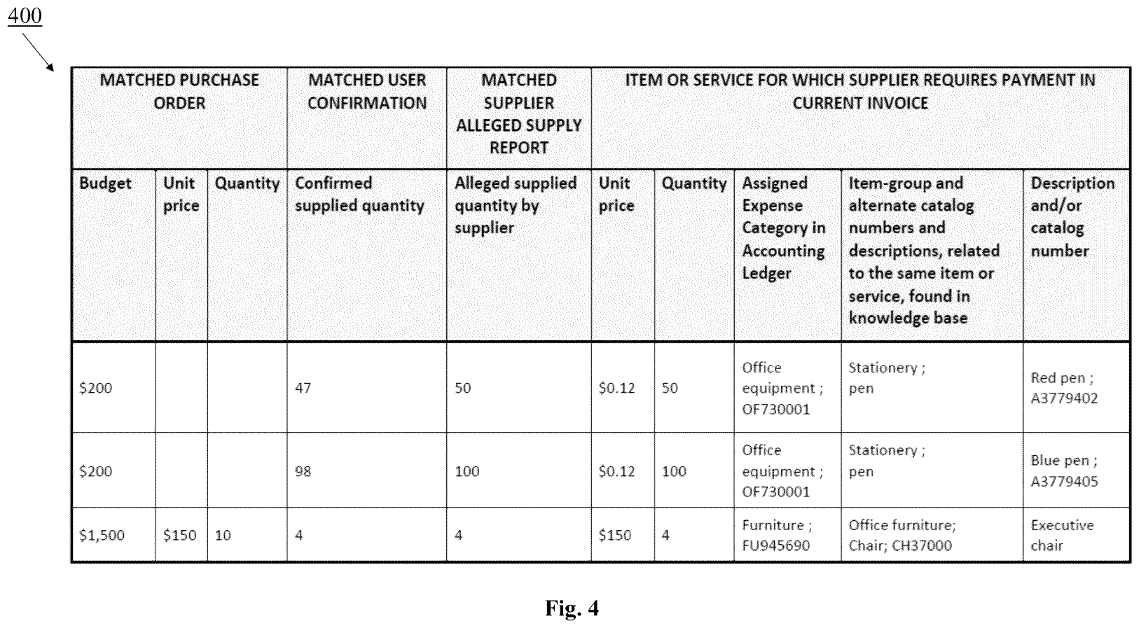

According to some embodiments of the present disclosure, the details of the extracted and validated items and services of the invoices or one or more related documents, i.e., matched items and services, may be converted into uniform format tables, such as uniform expenditure and income table 340 and for example, such as uniform expenditure and income table 400 in FIG. 4, to be stored in a data store, such as data store 150 in FIG. 1.

FIG. 4 is an example 400 of a uniform expenditure and income table, in accordance with some embodiments of the present disclosure, which demonstrates that the details of each item or service, for which the supplier requires payment, in the invoice itself or in any attached or referenced document, are automatically aggregated into a uniform structured digital table, while each item or service is already matched with the confirmed supplied quantities of that items or service and with the unit-price, quantity and total budget in the relevant purchase order.

The above uniform table—enables automatic approval of the payment required by the supplier, if no discrepancies were detected vs the supplied quantities or the ordered quantity, unit price or total budget, or, if any discrepancies were detected—proceed to handle them by the user or resolve them automatically by learning from previous user resolution of similar cases. In the specific example 400—the uniform table clearly shows discrepancies between the quantities for which the supplier requests payment and the supplied quantities. So, payment will be rejected till every discrepancy will be resolved.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for an automatic control of business income and expenses by a uniform processing of invoices, the computerized-method comprising:
(i) receiving a stream of searchable uniform format documents;
(ii) identifying invoices and one or more related documents in the received stream of searchable uniform format documents;
(iii) sorting the identified invoices and related documents into a plurality of queues, based on document type, document author and document recipient;
(iv) for each invoice or one or more related documents in each queue, extracting and validating item or service details and converting the validated item or service details into uniform format tables to be stored in a data store;
(v) assigning items or services for which a supplier requires payment, to entries in the uniform tables of supplied and ordered items and services to detect discrepancies, and operating an Artificial Intelligence (AI) model to learn from previous user assignments of the items or services by the user;
(vi) handling the detected discrepancies by the AI model based on previous user resolution of such discrepancies; and
(vii) displaying on a display unit of a computerized-device one or more unresolved discrepancies, for a user remedy thereof.

2. The computerized method of claim 1, wherein the detected discrepancies are selected from at least one of: one or more supply-discrepancies and one or more PO-discrepancies.

3. The computerized method of claim 1, wherein for each queue in the plurality of queues, the computerized-method is further comprising checking if an item or service price within the identified invoices exceeds a predetermined budget, defined in the purchase order for the specific item or service or to an items-group to which the item or service relates, and wherein displaying on the display unit of the computerized-device a price which exceeds a predetermined budget.

4. The computerized method of claim 2, wherein the computerized-method comprising identifying the one or more supply-discrepancies and the one or more PO-discrepancies based on the Artificial Intelligence (AI) model, wherein said AI model is learning a tolerance-percentage and identifying when the supply-discrepancies and the PO-discrepancies exceed the tolerance-percentage.

5. The computerized method of claim 1, wherein the item or service details and the supplied item or service details comprising: a quantity, a unit price and a total price.

6. The computerized method of claim 4, wherein said AI model is further comparing each item or service unit price to item or service unit price during a preconfigured period.

7. The computerized method of claim 1, wherein the one or more related documents include ordered and supplied quantities and prices of one or more items or services which are detailed in the identified invoices and one or more related documents.

8. The computerized method of claim 1, wherein the computerized-method is further comprising after the sorting, confirming authenticity of each invoice and related document, in the identified invoices and one or more related documents.

9. The computerized method of claim 8, wherein the authenticity confirmation includes checking a compliance with regulatory demands.

10. The computerized method of claim 1, wherein the computerized-method is further comprising assigning supplied items or services to the invoice, searching for an invoice in the uniform format tables which is stored in the data store which is assigned to the supplied items or services to identify a copy of the invoice and to mark the invoice as such.

11. The computerized method of claim 1, wherein the data store includes one or more uniform structured tables.

12. The computerized method of claim 1, wherein the computerized-method further comprising inferring a price deviation to each item or service and assigning to an expense category.

13. The computerized method of claim 1, wherein the computerized-method further comprising saving each invoice and related one or more documents and the confirmed assignment of each item or service within it in the data store in a universal format.

14. The computerized method of claim 13, wherein the computerized-method further comprising retrieving each invoice and related one or more documents and the confirmed assignment of each item or service from the data store and send it to the recipient of an invoice in a uniform format table, along with the invoice itself, to enable automatic processing by the recipient, while each item or service, for which payment is required by the supplier is assigned to a confirmed supply and to a corresponding purchase order.

15. The computerized method of claim 1, wherein the computerized-method is further comprising operating a categories-AI module to report expenses and income for each learned category.

16. The computerized method of claim 15, wherein each learned category is identified by the categories-AI module based on a ledger, which includes categorization of each income and expense, or based on a predetermined manual categorization for each item or service.

17. The computerized method of claim 1, when the details of the items or services, for which a supplier requires payment, do not exist in the invoice but in attached or referenced documents the computerized-method is further comprising extracting the details of the items or services from those documents and aggregating them into a uniform format table to be stored in the data store.

18. The computerized method of claim 1, wherein the computerized-method is further comprising:
(i) assigning each item or service to an expenditure category, which is learned from previous user assignment of such an item or service; and
(ii) comparing prices and quantities of each item or service to previous prices and quantities, to detect irregular one or more monetary transactions.

19. The computerized-method of claim 1, wherein the computerized-method further comprising verifying an originality and authenticity of each identified invoice and related documents, by confirming the identity of the supplier and the recipient of the document and verifying that the document looks like previous documents of the same type from the same supplier and the same recipient and that the invoice and related documents are digitally signed by the supplier or by a person who scanned the document, and wherein when the invoice and related documents, which should be confirmed for originality and authenticity, according to regulations, are not verified—the computerized-method is further comprising enabling a user to check the invoice and related documents and confirm its originality and authenticity by digitally signing the document, according to regulations.

20. A computerized-system for an automatic control of business income and expenses by a uniform processing of invoices, the computerized-systems comprising:
one or more processors;
a data store; and
a memory to store the data store;
said one or more processors are configured to:
(i) receive a stream of searchable uniform format documents;
(ii) identify invoices and one or more related documents in the received stream of searchable uniform format documents;
(iii) sort the identified invoices and related documents into a plurality of queues, based on document type, document author and document recipient;
(iv) for each invoice or one or more related documents in each queue, extract and validate item or service details and convert the validated item or service details into uniform format tables to be stored in the data store;
(v) assign items or services for which a supplier requires payment, to entries in the uniform tables of supplied and ordered items and services to detect discrepancies, and operating an Artificial Intelligence (AI) model to learn from previous user assignments of the items or services by the user;
(vi) handle the detected discrepancies by the AI model based on previous user resolution of such discrepancies; and
(vii) display on a display unit of a computerized-device one or more unresolved discrepancies, for a user remedy thereof.
